(19) United States
(12) Patent Application Publication
(10) Pub. No.: US 2018/0079531 A1
(43) Pub. Date: Mar. 22, 2018

(54) SYSTEM AND METHOD FOR DOCKING UNMANNED VEHICLES

(71) Applicants: ANDREW BENNETT, Belmont, MA (US); Shivali Chandra, Morris Plains, NJ (US); Rebecca Phoebe Jordan, Needham, MA (US); Devynn Nicole Diggins, Arlington, MA (US)

(72) Inventors: ANDREW BENNETT, Belmont, MA (US); Shivali Chandra, Morris Plains, NJ (US); Rebecca Phoebe Jordan, Needham, MA (US); Devynn Nicole Diggins, Arlington, MA (US)

(21) Appl. No.: 15/823,257

(22) Filed: Nov. 27, 2017

Related U.S. Application Data
(63) Continuation-in-part of application No. 15/082,498, filed on Mar. 28, 2016.

(51) Int. Cl. B64F 1/12; B64F 1/00; B64C 39/02; B60L 11/18; G05D 1/00; G05D 1/10

(52) U.S. Cl. CPC B64F 1/12; B64F 1/007; B64C 39/024; B60L 11/1833; B60L 11/1822; B60L 2200/10; G05D 1/101; B64C 2201/027; B64C 2201/20; B64C 2201/208; G05D 1/0011

(57) ABSTRACT

This document describes a system and method through which unmanned aerial vehicles (UAVs) and other vehicles (e.g., unmanned underwater vehicles (UUVs), also known as autonomous underwater vehicles (AUVs), unmanned water-surface vehicles (USVs), unmanned ground-surface vehicles (UGVs) and vehicles with the attributes and/or characteristics of more than one such category of vehicles (such as amphibious vehicles)), can be docked, with a device that can secure such vehicles, and information can be transmitted to and from such vehicles. The vehicles are secured through the use of magnetic fields produced by toggling magnets. The system also includes a means for transmitting information between the docking system itself, the vehicles and/or between the docking system and a command center, which may be a notable distance from the docking system, or among the docking system, the vehicle(s) and the command center.

### CLAIM OF PRIORITY

This application is a continuation-in-part of, and claims priority to, U.S. application Ser. No. 15/082,498 (filed on 28 Mar. 2016).

### COPYRIGHT NOTICE

A portion of the disclosure of this patent application contains material that is subject to copyright protection. Noting the confidential protection afforded non-provisional patent applications prior to publication, the copyright owner hereby authorizes the U.S. Patent and Trademark Office to reproduce this document and portions thereof prior to publication as necessary for its records. The copyright owner otherwise reserves all copyright rights whatsoever.

### FIELD OF INVENTION

The invention relates generally to an apparatus to which unmanned vehicles can be secured (docked) using magnetic fields produced by toggling magnets and through which information can be transmitted to and from such vehicles, and a method of securing and communicating with such vehicles.

### BACKGROUND

The uses of UAVs and the advances in their technology have grown substantially as computer-processing speeds have increased, stronger lighter materials have been utilized in UAV construction, and equipment component sizes have decreased. UAVs are increasingly being used for various activities and purposes, including, for example, numerous research applications. In some of the research applications, for example, UAVs gather information over vast areas of land, water, air space, or combinations of the foregoing. The scope of such research and other uses is at times limited, however, by the flying range of the UAVs, weather conditions and other factors. Likewise, as technology has developed (e.g. with GPS improvements, control systems becoming more enhanced, power system developments, and more), the capabilities of other unmanned vehicles (e.g., on land, on the surface of water, under water, and amphibious) have increased.

The travel distance of a vehicle, for example, is itself influenced by several factors. For instance, the needs for the vehicle to return to its point of origin to refuel/power up and to, as applicable, offload samples limit the distance the vehicle can travel away from the point of origin and return successfully. In some such cases, the UAVs, for instance, can safely travel no more than half their maximum distance or flying-time from the point of origin and then must commence the return journey to the origin.

Another limitation on the use of certain vehicles—ones that are slated to spend time at distal locations away from their points or origin—is the ability for the vehicle operators/users, controlling the travel at the origin, to secure the vehicles at the remote locations. Typically, the operator/user at the origin is expected, at best, to position the vehicles at the distal location with the help of personnel at such remote location, to transfer control to such other personnel, to have such personnel secure the vehicles after they have stopped, or combinations of the foregoing. If there are no remote personnel, then the operator/user at the origin might employ cameras on the vehicle or at the remote docking location to assist in such docking, assuming there is a signal connection between the operator/user at the origin, the vehicle and possibly the distal location (if, for example, a camera is situated there).

Without personnel at the remote locations to secure the vehicles, given their typical small size and light weight, there is also the greater possibility of misappropriation of the vehicle (depending on the openness of the docking area) and/or damage from adverse environmental conditions (e.g., structure/vehicle damage from movement caused by wind forces). Typically, however, the securing of the vehicles calls for personnel to be at, or travel to, the remote location(s) to physically engage straps, clips, bolts or some other form of mechanical constraints, the engagement of which being “hands-on” activities.

Traditional apparatus-attached securing means have limitations. The use of straps and other mechanical securing mechanisms, if controlled remotely, typically call for exactness in their operations and tolerances and for mechanics that draw their power from batteries or other electrical sources. Other docking systems may use magnetic fields to secure vehicles, but such fields are typically produced by electromagnet devices, which require power to initially secure the vehicles and oftentimes require continued power to maintain the placement and security of the vehicles. As with the use of the electric-powered mechanical systems, electromagnetic systems typically draw their power from batteries and/or from some other electrical sources. As one might imagine, when the power is cut off, depleted, or otherwise unavailable, the securing of the UAV that is maintained through the use of such power is in jeopardy. Further, the continued use of a field produced by electromagnetic devices could, in some instances, produce conditions that are not supportive of the environment in which the docking is to occur or of the operation of the docking system or vehicle, depending upon the other required functions (e.g., data transfer, readings, etc.).

Another personnel-requiring activity typically is the downloading/offloading of, for example, data and samples from the vehicles. With vehicles that collect data and/or samples as part of their mission, a human operator/user is traditionally engaged, in many instances, at the docking location (be it at the point of origin or at a remote location) to retrieve the vehicles' payload (e.g., data and/or samples collected during the vehicles' operations). As with the securing process, the need to engage personnel for such retrieval is a notable use of human resources and possibly an element of the process that lengthens the duration of the operation as a result thereof (e.g., with the increase wait for the availability of personnel to perform the retrieval or the travel time need for the personnel to arrive at the docking location to perform the retrieval).

The foregoing describes some of the shortfalls of the prior operations of vehicles (notable in their use, docking, securing, and the process of data/sample retrieval). The present inventions (both the apparatus and the method) are designed and have been developed to address these considerations and other challenges in the operation of vehicles.

### SUMMARY

The present invention comprises a system and method through which unmanned aerial vehicles (UAVs) and other unmanned vehicles can be docked, and information can be transmitted to and from such vehicles. One embodiment of the invention is a docking system capable of securing at least one vehicle. Such system comprises at least one surface configured to accommodate an area of vehicles in close proximity with the surface(s). Another element of the system would be a means for securing the vehicles in such close proximity to surface(s) through the use of magnetic fields produced by toggling magnets. The system also includes a means for transmitting information between the docking system itself and the vehicle(s). In addition to the transmission of information between the docking system and the vehicles, there is also a means for transmitting information between the docking system and a main control center, which may be a notable distance from the docking system. The invention in this embodiment would also include a means for transferring, from the docking system, a source of energy needed to power/refuel the vehicles.

Other embodiments of the inventive apparatus may include means for protecting the vehicles from unfavorable environmental conditions or means of extracting samples from the vehicles (e.g., a means of taking off and reloading a consumable or other material). Still other embodiments may include means of extracting certain information from vehicles, uploading information to same, inspecting the physical condition of such vehicle, and cleaning them. Still another embodiment of the invention includes use of the magnetic fields produced by toggling magnets that lock the vehicle(s) in physical contact with a surface with the docking system. A more sophisticated embodiment of the present invention includes means for monitoring environmental conditions and other local circumstances in geographical proximity of the docking system and means for analyzing samples.

The invention as a method would comprise the step of transmitting signals between docking locations and a main control location. This communication could be used, in part, to facilitate the transmitting of signals between vehicles and the docking locations. With the communication between the docking locations and the vehicles established (e.g., for guidance during travel), the vehicles can be positioned, using this embodiment of the inventive method, in close proximity with the docking locations. Thereafter, the vehicles can be secured in close proximity with the docking location through the use of magnetic fields produced by toggling magnets. If and as needed, the inventive method could include the step of transferring energy to power/refuel the vehicles from the docking locations.

Another embodiment of the inventive method includes the step of protecting vehicles from unfavorable environment conditions. The step of extracting and/or storing samples from the vehicles may also be added. In another embodiment, the invention includes the step of preparing vehicles for deployment. Such preparation could include, for example, the extraction of certain information from such vehicles, the uploading of information to such vehicles, the inspection of the physical condition of such vehicles, and the maintenance of the vehicles. Still in another embodiment of the present inventive method, the magnetic fields lock an area of the vehicles in physical contact with a surface of the docking locations. The magnet field is generated via toggling magnets. The signal between the docking locations and the distal location main control may be transmitted via over-the-air technology and the securing the vehicles may be made while the docking locations are mounted on movable objects. The method may also have the transmission of information between the docking locations and the vehicles while the vehicles are not in close proximity with the docking locations. As such, an additional step could be the coordinating of travel of the vehicles to and from the docking locations. The foregoing could be accomplished by transmitting information between the docking locations and the vehicles that can control the flight time of, destination of, information and sample gathered by, and other operations of the vehicles. The inventive method may also include the steps of monitoring environmental conditions and other local circumstances in the geographical proximity of the docking locations and analyzing samples. Further, the securing means, when it employs magnetic fields produced by toggling magnets, could facilitate a physical connection and transmission of information to and from the vehicles (e.g. holding still a vehicle while a physical connector is engaged, and the connector could be used for information transfer, fuel transfer, handling of other consumables, and other operations.)

### BRIEF DESCRIPTION OF THE FIGURES

FIG. 1 shows a top view of an embodiment of docking element of the present invention.

FIG. 2a shows a cut-away view and FIG. 2b shows an exploded view of one of the toggling magnets.

FIG. 3 shows an arrangement of embodiments of the docking elements, UAVs and a control center.

FIG. 4 shows a side view of an embodiment of the docking element of the present invention with a transfer conduct, motor and retractable cover.

FIG. 5 shows a side view of an embodiment of the docking element with a hovering UAV, where docking element includes a storage area, a mechanical arm and a collector.

FIG. 6 shows an embodiment of the present invention with three docking elements.

FIG. 7 shows an embodiment of the docking element resting in the cargo-holding area of a vehicle.

FIG. 8 shows an embodiment of the docking element, a set of UAVs and a command center where signals are transmitted between the UAVs and both the docking element and the command center.

FIG. 9 shows an arrangement of embodiments of the docking elements, a UUV and a control center.

FIG. 10 shows an arrangement of embodiments of the docking elements, a USV and a control center.

FIG. 11 shows an arrangement of embodiments of the docking elements, a UGV and a control center.

### DETAILED DESCRIPTION

The inventive docking system provides a location for one or more UAVs to land and to be secured. In one preferred embodiment of the present invention, the docking system, when deployed a distance from the UAV's points of origin, is capable of communicating with the human operator/user at the points of origin or at different locations, or, if the operation is more automated, with the programmed equipment at such point of origin or different location. The UAVs accommodated by the docking system could be rotary/hovering, fixed-wing or any combination. The docking system is fundamentally the same, but may be adapted to the needs of specific UAVs (e.g. when a sample removal and storage system are desirable due to the missions of the UAVs). The main control center may comprise software that includes a mission planner and a user interface and could be run on any computer that has networking and/or satellite communications access. The inventive docking system has the advantages of reach (the UAV can fly to any location within its operational radius), speed (relatively instant response), timing (the UAV can launch at any time, barring unforeseen conditions) and mobility (the UAV can go anywhere with a docking system that can be positioned almost anywhere).

In general, the apparatus of the present invention allows UAVs to be positioned in a location where the UAVs are intended to stay for a relatively long time before being deployed or redeployed. The UAVs can be any vehicle of convenience (e.g. quadcopters, hexacopters, fixed-wing, or helicopters). Such vehicles would preferably include wireless communications technology through which they could communicate with the ‘main control center’ and/or the docking systems and may also (or alternatively) include an autonomous autopilot capable of navigation. For cluttered environments, the UAVs would preferably include functionality through which they could ‘sense and avoid’. Also, the UAVs could preferably be capable of carrying a mission-specific payload (camera, sample collector, other sensors).

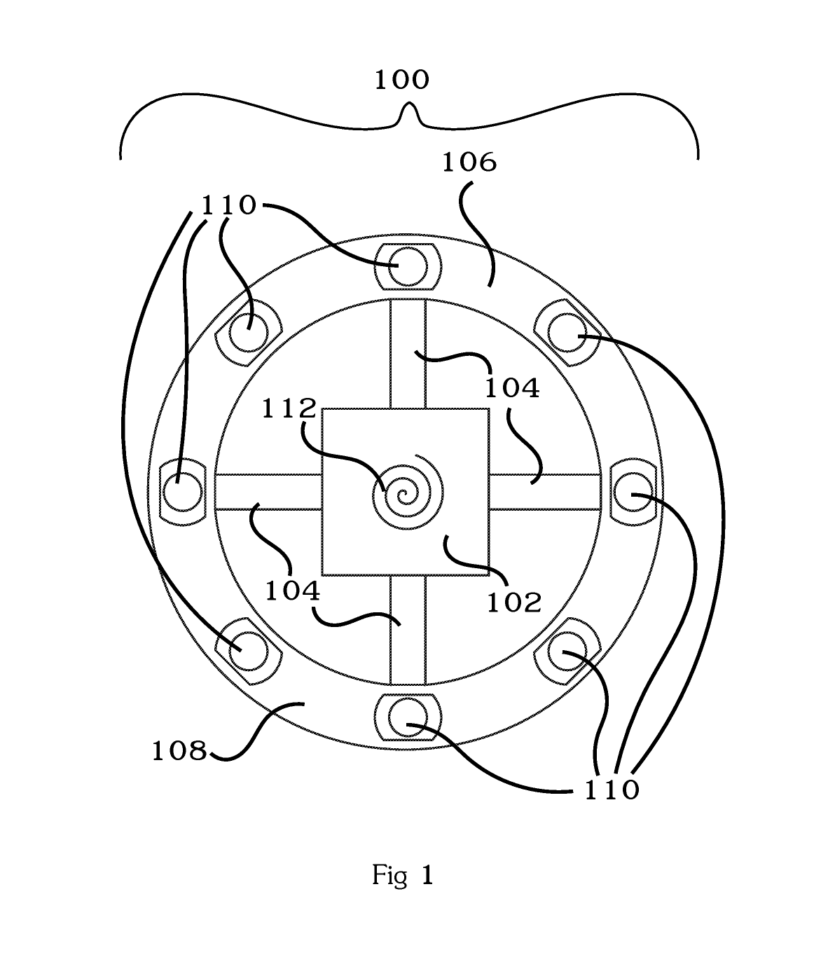

FIG. 1 shows one embodiment of the present invention—docking system 100. Base 102 is the foundation of the docking system 100. One of ordinary skill in the art would know that base 102 could be configured as a stand that merely sits on the ground or other surface or could be secured through fasteners of other mechanism to hold docking system 100 in place. For example, base 102 could be bolted on a platform located in a remote geographical area, strapped to the deck of a boat traveling at sea, attached to a motor vehicle or otherwise fixed in association with a desired location or transporting structure.

Docking system 100 also has rods 104 that connect platform 108, with surface 106, to base 102. As shown in FIG. 1, surface 106 is at the top of platform 108 and platform 108 is in the space of a ring. One of ordinary skill in the art would know that the dimensions and configuration of surface 106 could be different as the dimensions, configuration and other aspects of platform 108 are changed. It is also possible that surface 106 is an outer area of base 102. Depending upon the desired operation and placement of docking system 100, surface 106 could be situated under base 102 (for example, if docking system 100 was to be hung in its desired location with UAVs docked under docking system 100) or on the side of base 102 (if, for example, the applicable UAV is to be secured on the side of docking system 100).

Preferably, surface 106 is configured to accommodate an area of at least one UAV in at least in close proximity with surface 106. As suggested elsewhere in this document, docking system 100 may be used in connection with UAVs of various sizes, capabilities, designs, and configurations. The ability to accommodate a particular UAV is somewhat dependent upon the portion of, and the manner in which, the UAV is to be secured by, for example, docking system 100. The UAV would need to be positioned close enough to that operational part of docking system 100 that will secure the UAV. Accordingly, the access to surface 106 in the proximity of the ‘docking’ area needs to be adequate. In particular embodiments of the present invention, the accommodation for the area of surface 106 is sized and configure to allow therewith the proximate locating of an adequate area of a UAV docking gear. Such configurations may also have the securing means in close proximity to the accommodating area while other configurations could have the securing means within the accommodating area. In a further embodiment of the invention, the accommodation area may be adjustable for docking UAVs of various sizes and configurations.

FIG. 1 also shows magnet units 110. In this particular embodiment of the present invention, there are four magnet units 110 and they are spaced evenly within platform 108. In this configuration, magnet units 110 can secure the UAVs by generating a magnetic field that attracts a desired portion of the UAVs (such as, for example, metal docking gear) toward platform 108 and then locks that portion of the UAVs in close proximity with platform 108. When the magnetic field is strong enough, the portion of the UAVs may be held in contact with magnet units 110, platform 108, or both. One of ordinary skill in the art would know that there are numerous ways to generate the desired magnetic fields through, for example, the use of one or more magnets, the use of stronger magnets, differing positioning of magnets in and around the docking system, and the use of other mechanisms (besides magnets) that can generated desirable levels of magnetic forces. In a preferred embodiment of the present invention, the power of such magnetic fields can be varied such that, for example, a greater magnetic field strength is used to secure the UAVs when docked and the field is decreased and/or turned off for disengagement of the UAVs. Further, it is preferable that the field level could be increased during docked times as needed due to changes in the weather and other conditions in the environment of the docking system.

Connectors 112 are also shown in FIG. 1. In the embodiment of the present invention shown in FIG. 1, base 102 could contain, for example, electronics capable of communicating with UAV. In this embodiment, connectors 112 are the elements that can be physically connected to UAVs that have compatible ports. One of ordinary skill in the art would recognize that the communication between UAVs and the inventive docking system could also be accomplished through the use of wireless technology. Further, connectors 112 could be engaged with the UAVs by the UAVs causing the connection (e.g., coming to rest with the positioning of connectors 112 within the applicable ports of the UAVs) or with, for example, mechanics of base 102 moving connectors 112 into such ports.

In a particular preferred embodiment, docking system 100 could have the ability to communicate wirelessly with the UAVs and with one or more human operators/users situated in one or more locations that are distal from the location of docking system 100. In addition, the docking system could be adapted to capture, release and store UAVs against any weather.

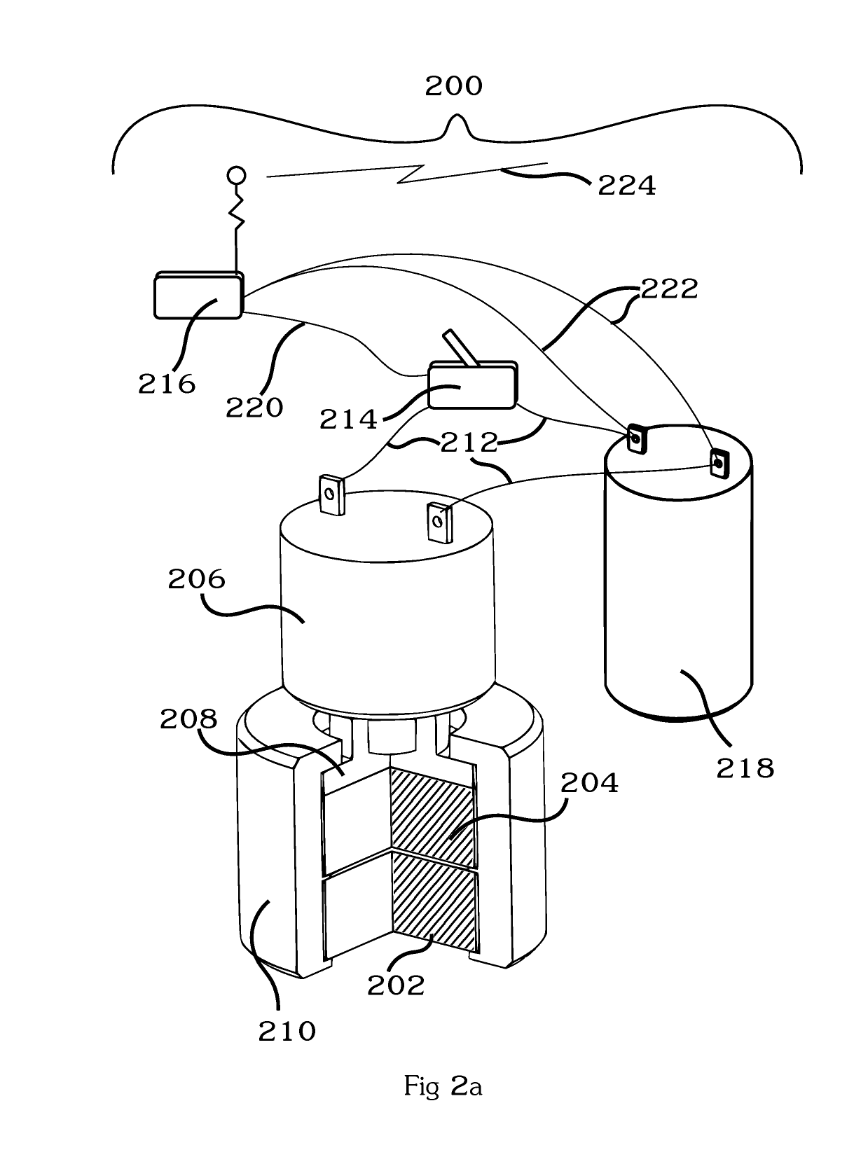

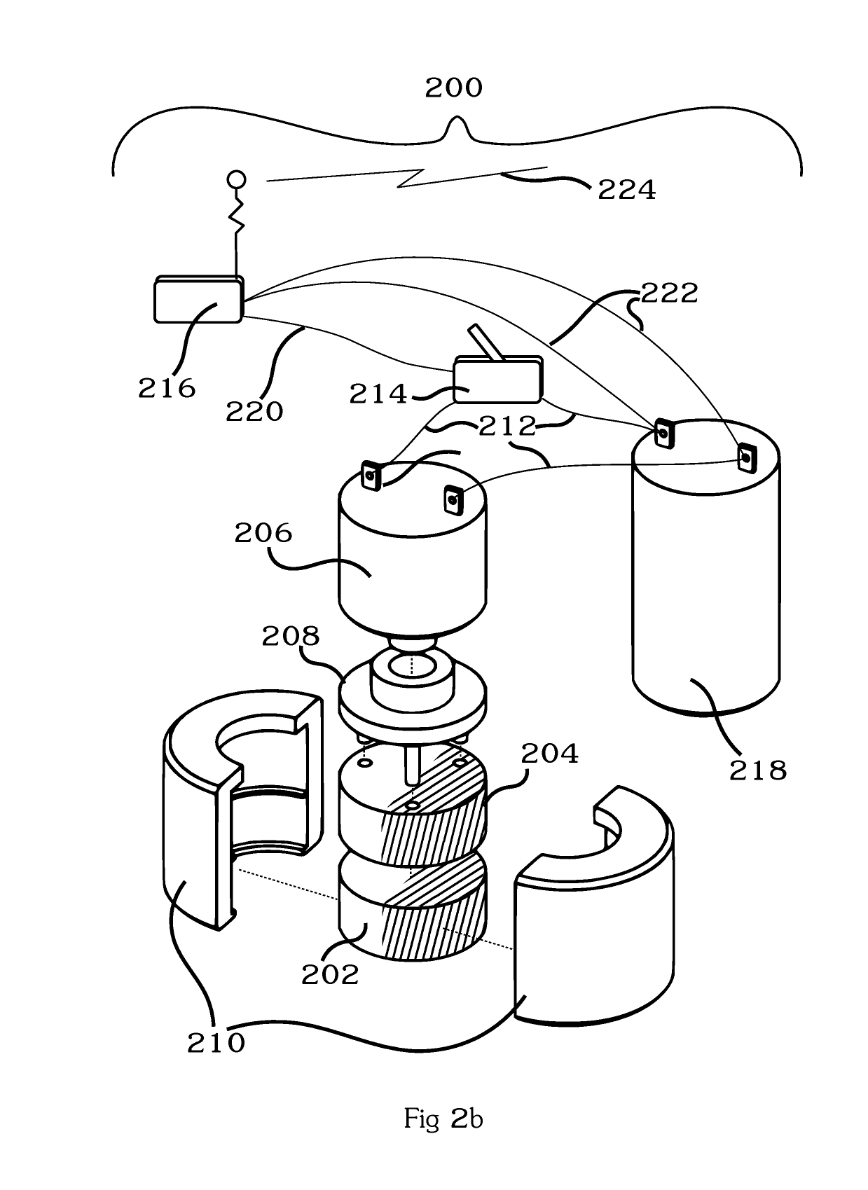

FIGS. 2a and 2b show an embodiment of the magnet units. Magnet unit 200 includes magnet 202 and magnet 204. In one alignment of magnet 202 and magnet 204, the magnetic fields generated by each element cancel each other—the “off” position. In the “on” positions, in this particular embodiment, magnet 204 moves so that the magnetic fields are active and thus capable of producing a force that draws metal surface toward the surface of magnet 204. Magnet 204 is moved through the activation of motor 206, which is attached to magnet 204 through spacer 208. Magnet 202 and magnet 204 are encased in case 210, which is preferably made of steel and is thus capable of facilitating the desirable direction magnetic field produced when magnet unit 200 is in the “on” position. Wires 212, through which electricity flows to and from motor 206, are connected between switch 214 and motor 206, between switch 214 and battery 218, and between battery 218 and motor 206. Accordingly, when switch 214 is in the “on” position, electricity travels through the circuit thereby created to motor 206. Switch 214 is also connected to receiver 216 via wire assembly 220 and receiver 216 is connected to battery 218 via wire assembly 222. As such, when receiver 216 receives a signal to change the orientation of magnetic unit 200, receiver 216 activates switch 214.

Accordingly, magnet unit 200 is thus turned “on” and “off” as receiver 216 receives signal 224, which dictates whether electricity from battery 218 is allowed to activate motor 206 to “turn on” magnet unit 200 or to “turn off” same. In the rest state, the only electricity flowing is to receiver 216, which is listening for instructions. Thus, magnet unit 200 only uses noticeable power when changing state. Once in the new configuration/state, only receiver 216 maintenance power is required if magnet unit 200 is not being toggled on or off.

Magnet unit 200 could be arranged in the inventive docking system such that the sum of their magnetic field strength could vary. For example, if more magnetic force is required, additional magnet units 200 of an array could be toggled from the “off” to the “on” state. Further, the inventive device could comprise magnet units 200 of differing strengths. Such a configuration could facilitate the increase and decrease in the generated magnetic field by the toggling of the differing magnet forces of the varying magnet units 200 in designated ways and at specific times. Additional field strength is useful for multiple applications and operations of the inventive docking system. For example, when there is a need for a powered takeoff, additional holding strength could be “turned on” to thereby allow a UAV to power up propellers prior to launch. When appropriate, magnet units 200 in the array could be disabled (i.e., turned off in a desired timing) to allow a “full thrust launch” scenario, much like the method used by aircraft carriers to launch their aircraft. Conversely, some of magnet units 200 in the array could be “turned off” while others are left “on”, thereby reducing the holding strength of the present invention with respect to the UAV in question. By so lowering the holding strength, a UAV could be moved by a manipulator arm or some other mechanism to reposition it while at the same time keeping enough holding force to prevent loss of the UAV. For example, the UAV might have to slide from a docking spot to a servicing location (if the magnetic field were completely missing the UAV might be knocked/blown away).

In another operative process, magnet units 200 could be used, for example, as part of the magnetic field's calibration. For instance, through the selective toggling of magnet units 200 at various locations of the inventive docking system, a user could test a UAV's on-board magnetic sensors.

Yet another process that is executable with the use of magnet units 200 is the varying of the magnetic array. A use of the inventive docking system with a collection of magnet units 200 could be the selective toggling of the units “on” and “off” as desired to adjust and change the overall geometry of the magnetic holding force. Such changes and adjustments may be required for differing reasons (e.g., environment conditions, weight of the UAV, the changing weight of the UAV as payload is stored in it or removed from it). By way of further example, such toggling could be used where (A) the inventive docking system has multi-UAV launch and recovery zones (e.g., UAVs in one part of a docking zone might be released separately from other UAVs, requiring the selective disabling of one set of magnet units 200 while keeping others active), (B) there is a need to create a “magnet free” zone for servicing (e.g. if a given payload or other part of the system would be adversely affected by magnetic fields, then disabling specific magnet units 200 to allow a payload swap, battery change, etc. might be preferable); and (C) customization of the docking zone geometry is beneficial (e.g., by selectively enabling specific sets of magnets, the geometry of the active docking zone could be changed according to the requirements of the specific drone which needs to land).

One of ordinary skill in the art would realize that the use of magnet units 200 as part of the inventive docking system likely has other attributes and can foster additional benefits that aid in the operation of the inventive docking system and better facilitate the docking and release of UAVs.

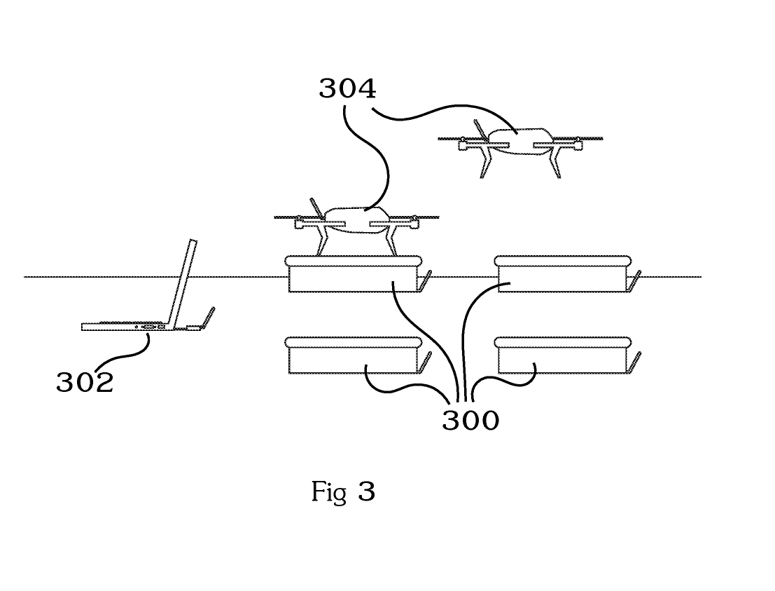

FIG. 3 shows multiple deployments of the present inventive docking systems 300 and a depiction of remote location 302. In a preferred embodiment, one or more docking systems 300 can be in communication with remote location 302 through the transmission of information between one or more docking systems 300 and remote location 302. An operator/user could, thus, operate remote location 302 as a main control center. In such a configuration, the operator/user could operate functions of applicable docking systems 300. The human operators/users and/or the equipment at remote location 302 could coordinate some or all of the activities of docking systems 300. If networked, the main control center could communicate and coordinate the activities of more than one docking system 300, while also influencing the mission of UAVs 304. Such center could accomplish this coordination with UAVs 304, for example, through signals transmitted first to one or more authorized docking systems 300. Amongst the components of the networked elements, the main control center could be tasked with high level planning and administration of human operator/user authorizations.

In a further embodiment, remote location 302 could be in communication with UAVs 304. In still a further embodiment, one or more docking systems 300 could also (with remote location 302), or could instead (of remote location 302), be in communication with UAVs 304. In certain embodiments, the transmission of information and other communication could be accomplished through over-the-air (e.g., wireless) communications, such as, for example, through radio signals, cellular technologies or other means, now known or to be known. An individual UAV could fly circuits from docking systems to other docking location(s), thereby extending the range of the UAV.

In a more automated configuration, missions for UAVs 304 are planned by, for example, an autonomy engine, situated at remote location 302 and/or within docking system 300. Such an engine could calculate the paths UAVs 304 would fly, what data they would collect, how many UAVs would be deployed, and whether to place UAVs 304 in ‘sleep’ or ‘wake up’ mode (for very long endurance missions or missions that are waiting for specific conditions, such as immediately after a storm, during a seasonal animal migration, etc.). Such an engine could also notify docking systems 300 of upcoming weather conditions to assist local planning.

The human operator/user could program the docking system via the user interface. He/she could program missions, monitor UAVs in communication with the docking systems, set global parameters, choose specific targets, and check the health of the docking system or any element thereof. Such human operators/users could also, for example, select specific docking system locations or UAVs and monitor them closely. In addition to high-level mission parameters, the human operators/users could select specific UAVs or docking systems for direct access to data where the docking system requires human intervention (e.g. the human is required to select or approve a target).

Docking systems 300 may also be able to communicate with an incoming UAV 304 with a notice to end its mission prematurely due to adverse weather conditions at, or anticipated for, the locations of docking systems 300. Accordingly, docking systems 300 may be equipped with weather monitoring equipment, external cameras and/or other sensors appropriate to the mission/location they are in. As discussed in more detail below, some docking systems may also have the ability to store and/or process physical samples.

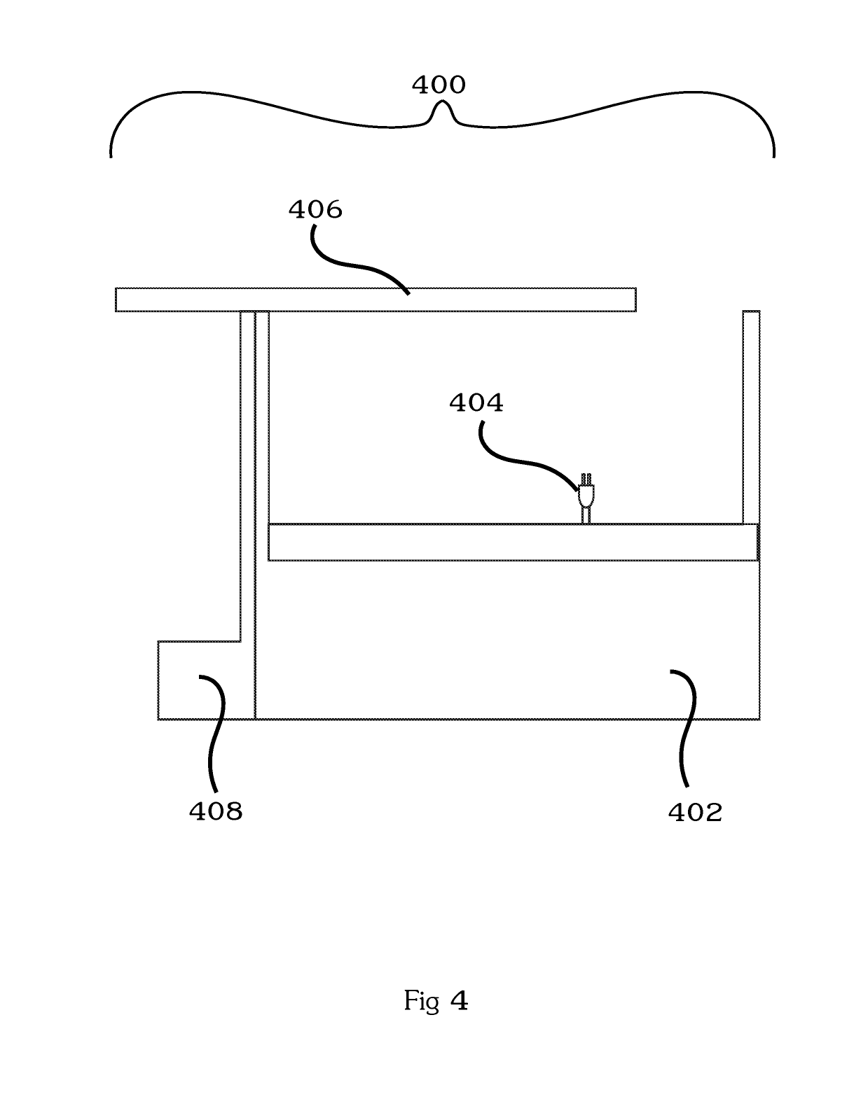

FIG. 4 shows docking system 400 with base 402 and transfer conduit 404. With this embodiment of the invention, a form of energy for UAVs (for example, fuel or electricity) could be transferred from the base to the UAVs. In another embodiment of the present invention, transfer conduit 404 also has the capabilities and functionality of connectors 112, with the ability to also facilitate the transfer of information between UAVs and docketing system 400. One of ordinary skill in the art would know that there are a number of ways of and configurations for physically connecting a UAV to docking system 400 to enable energy and other transfers. This particular embodiment also has retractable cover 406 and motor 408. In this configuration, motor 408 can be used to move retractable cover 406 over a UAV docked in docking system 400, thus providing some level of protection from the surrounding environment and changing weather conditions. One of ordinary skill in the art could conceive of other means of protecting a docked UAV (e.g. wholly or partially, remotely or locally activated, hard or soft material, and other options).

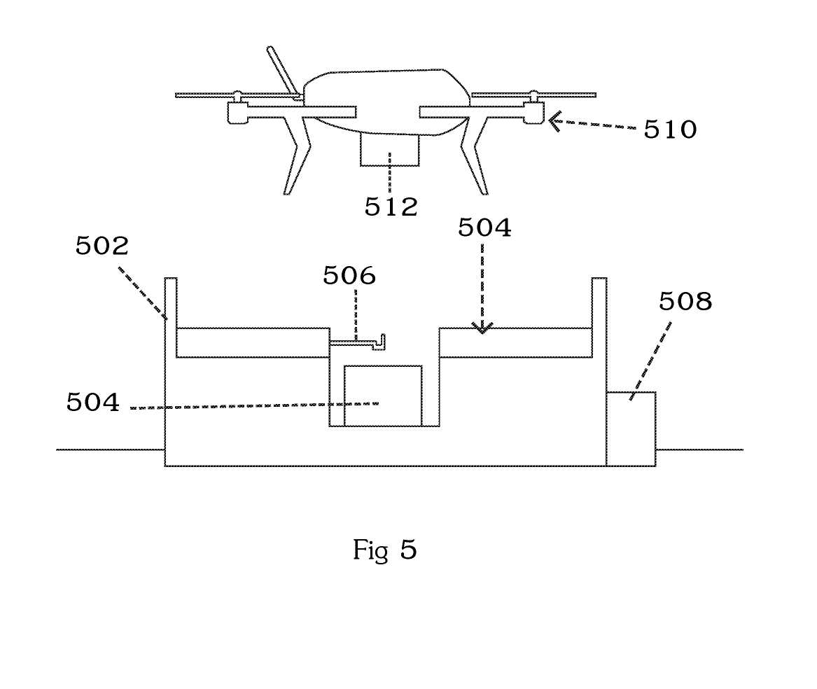

FIG. 5 shows docking system 500 with base 502 and storage area 504. In this configuration of the present invention, storage area 504 could be used, for example, as a repository for samples (e.g., material, consumables, artifacts and possibly more) collected by UAV 510. Mechanical arm 506 could be used to grasp, for example, a container attached to UAV 510 that holds sample 512. Thereafter, mechanical arm 506 could be used to lower, in this case, the container and/or the sample therein into storage area 504. One of ordinary skill in the art would know that the configuration of storage area 504 and the extraction system (used to move sample 512 from UAV 510 to storage area 504) may vary in design and operation. Accordingly, if by chance UAV 510 is lost, sample 512 will be preserved. This capability and functionality of the docking system 500 adds to its usefulness over long periods of time—for as long as it is functional and in place. In another embodiment of the present invention, docking system 500 has the capacity to accept delivery of physical samples of interest, such as, for example, samples of water, air, vegetation, and more. The enhanced version of this embodiment also includes the capability of analysis in-situ or preparation of the sample for analysis after such time as a human operator/user recovers the sample from storage area 504.

By way of further example, docking system 500 could also be equipped with the capacity to receive, using a mechanism like mechanical arm 506, packages and documents. For example, docking system 500 can be on standby to receive/transport material or documents when needed, regardless of time of day. One advantage of such a system is lower cost delivery—relative to the costs of a human courier. Examples of such an embodiment of docking system 500 in operation include ship-to-shore document transfer, rapid part delivery in large operations such as mining and forestry.

Mechanical arm 506 might also be conversely used to load materials from, for example, storage area 504 or elsewhere onto UAV 510. Such an operation could be part of the preparation of UAV 510 for its mission. Other means could of course also be used for such preparation and such preparation could include, for example, the extraction of certain information from a UAV, the uploading of information to the UAV, inspection of the physical condition of UAV, and the other maintenance thereof, such as cleaning.

Via collector 508, docking system 500 also individually collects samples in a fashion, for example, similar to the collection performed by UAV 510. This ‘parallel’ operation could be used, for example, to collect contemporaneous data from the UAVs and the docking location for comparison of readings from their separate locations. As another example, through the use of collector 508, docking system 500 could collect a sample during a transient event that is hard to reach or predict and, in essence, warn the UAVs. Other examples include samples collectible at the location of docking system 500, for comparison with the readings from the UAVs and/or independently, are readings of post-storm runoff, plant blooms, migrations, eruptions, and more.

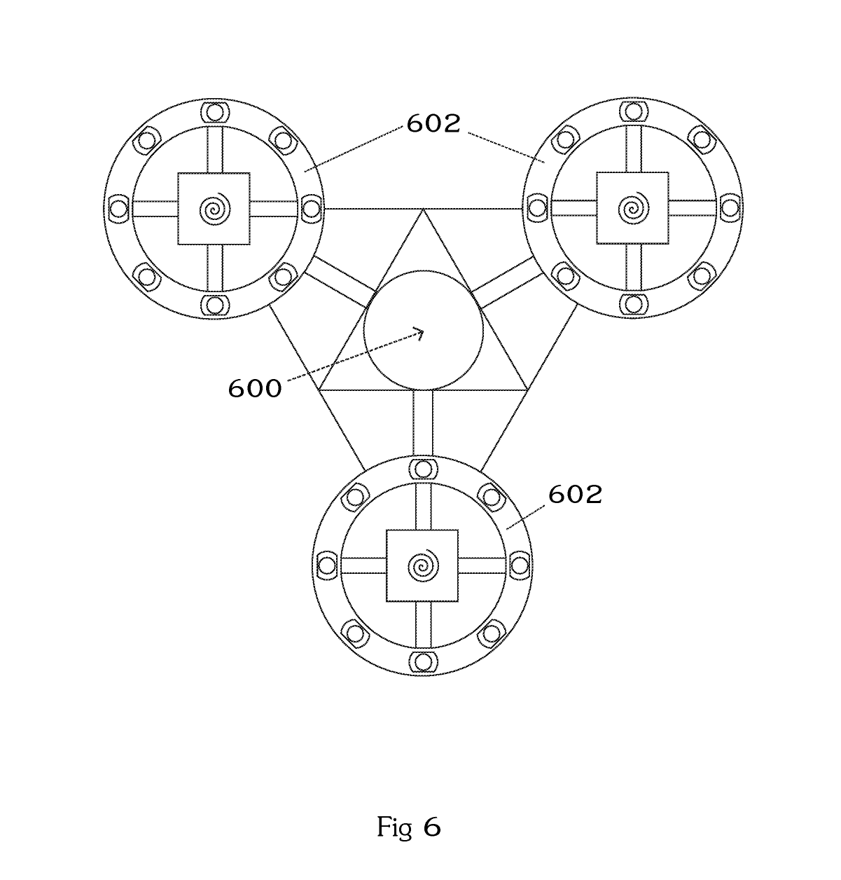

FIG. 6 shows docking system 600, which has, in essence, three surfaces 602, each of which is configured to accommodate an individual UAV and through which such individual UAV may be secured. In this particular embodiment, the UAVs may be secured simultaneous or one or more of surfaces 602 may be open while one or more of other surfaces 602 each secure a UAV.

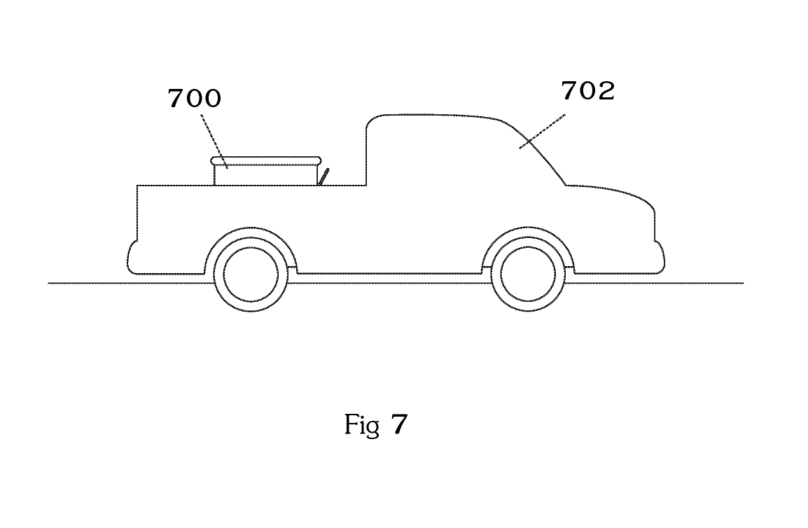

FIG. 7 shows docking system 700 mounted on land-bound vehicle 702. This mounting may be accomplished through a variety of means in differing configurations. One of ordinary skill in the art would realize that docking system 700 could also be conceivable mounted on water-operational vehicles and aerial apparatus (the latter allowing a UAV to be, for example, docked to another inflight apparatus). Other movable mountings are also possible. Conversely, as stated above, docking system 700 could be mounted on, for example, the top of a building after or instead of being mounted on a movable apparatus.

Since docking system 700 could be permanently situated (once located in a desirable place), it can be used to perform long-term event sampling. For example, docking system 700 could collect samples at intervals over relatively long periods of time (e.g. a year, a season or a slowly-evolving event). The analyses and/or stores samples by docking system 700 over such time can help to create a more complete picture of an event. Examples of the kinds of events that docking system 700, when permanently fixed, could be engaged to sample include Harvard Forest Monitoring (a multi-year data collection project), sampling around an active volcano, a seasonal event, monitoring an oyster reef over a winter, and more.

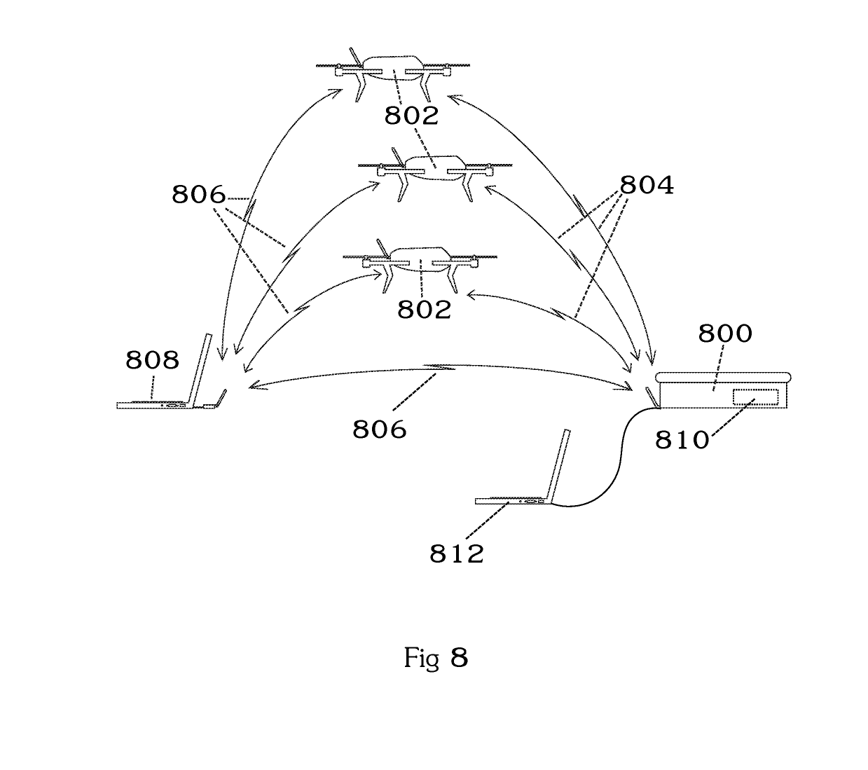

FIG. 8 shows an example of how a multitude of UAVs 802 could interface with a single docking system 800. Signals 804 transmit information between docking system 800 and UAVs 802. In such a configuration, an operator/user could coordinate the missions of UAVs 802 relative a specific location. Further, docking system 800 could be in communications with command center 808 through signal 806. Such facility to communicate could allow to an operator/user to thus, through this particular embodiment of the invention, coordinate the activities of UAVs 802 from a location remote from docking system 800 and, if and as necessary, to also remotely manage the activities of docking system 800. Another element a particular embodiment of the present invention is a means for transmitting information between, for example, docking system 800 and command center 808 to coordinate travel by UAVs 802 to and from docking system 800. Such information could include, for example, data to control the flight time of, destination of, information and sample gathered by, and other operations of one or more UAVs 802. Command computer 808, electronically connected to docking system 800 (via signal 806), provides a means for monitoring, for example, environmental conditions and other local circumstances in the geographical proximity of such docking system as part of the overall system. Other activities, for example, the analysis of samples gathered by UAVs, could be conducted by evaluator 810. Locally, in this embodiment, computer 812 is available to communicate directly with docking system 800 regarding, for example, specifics of the operation of docking system 800 in and unique to the location of docking system 800.

Docking system 800 could also be ‘programmed’ to deploy UAVs 802 (e.g. releasing the magnetic hold) at random intervals. An example of such a process in use would be docking system 800 releasing one of two UAVs 802 so they can be deployed to monitor a facility at random intervals, having one of UAVs refueling while the other is used to conduct surveillance. Such scheduling could, for example, help prevent someone from avoiding detection or deter ‘bad acts’ by a person that would otherwise not be as easily observed. Examples of such uses include monitoring of material caches in remote staging areas, monitoring around sensitive facilities, ensuring compliance to prevent pollution discharges, security around offshore facilities, military base security, and more.

As mentioned earlier, the UAVs could sit in the docking systems, in some cases, immune to local weather conditions, until the time to deploy/redeployed. They then could perform their missions and return to the docking systems for servicing or to await recovery. In one specific embodiment of the present invention, the docking system is capable of securing UAVs, store them in any weather, recharge or swap out batteries, clean the UAV, extract samples from the UAVs for storage or analysis, and service the UAVs. Such a version of the docking system is intended to act as a combination hangar, storage unit and base of operations for the UAVs. As mentioned, the docking system can be equipped with satellite and/or cellular communications to communicate with the human operators/users as well as wireless communications to send signals to and receive them from the UAVs.

With regards to the inventive process, the present invention is a method of communicating with and securing one or more UAVs. This process includes the step of transmitting a signal between a docking location and a distal location, such as, for example, a main control center. The process also includes transmitting a signal between such docking location and UAVs. The foregoing enables the positioning such UAVs in in close proximity with the docking location. Once the applicable UAVs are in the desired position, they can be secured in close proximity with the docking location through the use of magnetic fields produced by toggling magnets. After the UAVs are adequately secured, any energy needed to power the UAVs can be transferred from the docking location to the applicable UAVs.

In a further embodiment of the present invention, the process includes the protection of one or more the UAVs from unfavorable environment conditions. Further, the present invention may include the extraction of samples from such UAV(s). If there is capacity, the samples may be stored in or near apparatus at the docking location. Conversely or in addition, the process could include the preparation of the UAV(s) for deployment. Such preparation could include the extraction of certain information from such UAV, the uploading of information to such UAV, inspection of the physical condition of such UAV and the maintenance of the UAVs. In a preferable version of the present invention, the UAVs are secured in close proximity to the accommodating area at the docking location. This area would facilitate the use of the magnetic fields produced by toggling magnets in locking a docking area of the UAVs into physical contact with a surface of the docking location.

Also, in a specific practice of the present invention, the signal between the docking location and the distal location (e.g., a main control center) is transmitted via over-the-air technology. In an optional practice, the securing of the UAVs can be accomplished while the docking location is mounted on a movable object. Further, the transmission of information between the docking location and the UAVs could occur while such UAV are not in close proximity with the docking location.

With respect to the missions of the UAVs, the practice of the invention may include coordination of the travel of the UAVs to and from the docking location. This coordination may be accomplished in part by the transmission of information between the docking location and the UAVs, with such information being capable of controlling the flight time of, destination of, information and sample gathered by, and other operations of the UAVs. The monitoring of environmental conditions and other local circumstances in the geographical proximity of the docking location may also be part of the practice of the present invention, along with the analyzing of samples. Further, the securing means, when it employs magnetic fields, could facilitate a physical connection and transmission of information to and from the UAVs (e.g. holding still a UAV while a physical connector is engaged), and the connector could be used for information transfer, fuel transfer, handling of other consumables, and other operations.

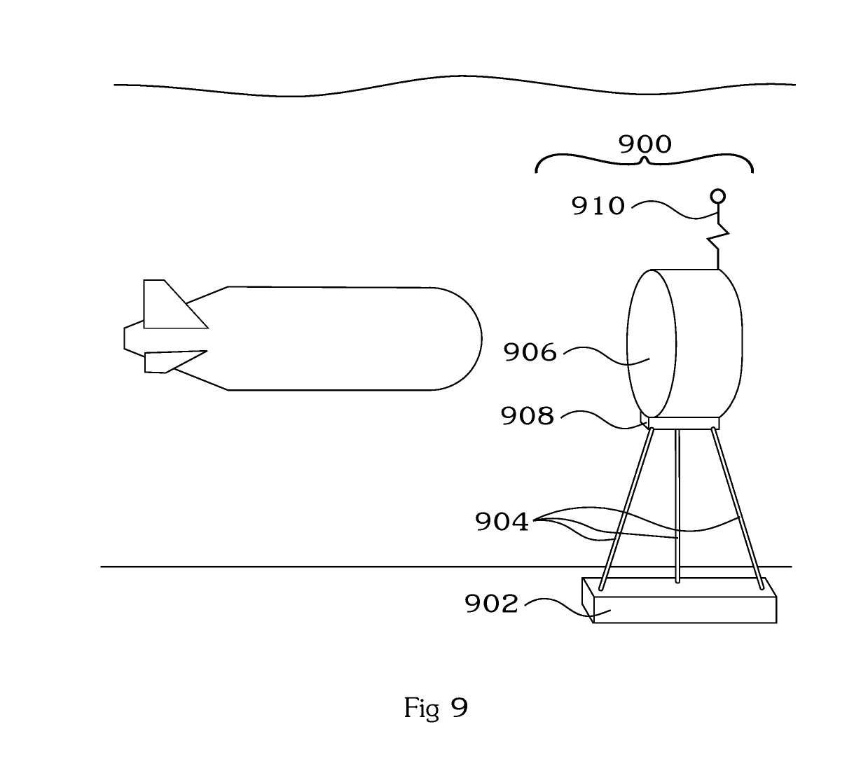

FIG. 9 shows an embodiment of the present invention that can be used with UUVs. In this general case, the apparatus of the present invention allows UUVs to be positioned in an underwater location where the UUVs are intended to stay for a relatively long time before being deployed or redeployed. Such vehicles would preferably include wireless communications technology through which they could communicate with the surface-located ‘main control center’ and/or the docking systems and may also (or alternatively) include an autonomous autopilot capable of navigation underwater. For cluttered environments, like the UAVs discussed previously, such UUVs would preferably include functionality through which they could ‘sense and avoid’. Also, the UUVs could similarly be capable of carrying a mission-specific payload (camera, sample collector, other sensors).

In this particular depiction of one embodiment of the present invention—FIG. 9 shows docking system 900. Base 902, the foundation of docking system 900, has been secured into the underwater floor. Docking system 900 also has rods 904 that connect mooring place 908, with surface 906, to base 902. As shown in FIG. 9, surface 906 is around the inner circumference of mooring place 908 and mooring place 908 is in the space of a ring. One of ordinary skill in the art would know that the dimensions and configuration of surface 906 could be different as the dimensions, configuration and other aspects of mooring place 908 are changed. It is also possible that surface 906 is an outer area of base 902. Depending upon the desired operation and placement of docking system 900, surface 906 could be situated external to mooring place 902 (for example, if mooring place 902 was to a flat surface at its desired location with UUVs docked on top of docking system 900) or on the side of base 902 (if, for example, the applicable UUV is to be secured on the side of docking system 900).

Preferably, surface 906 is configured to accommodate an area of at least one UUV in at least in close proximity with surface 906. As suggested elsewhere in this document, docking system 900 may be used in connection with UUVs of various sizes, capabilities, designs, and configurations. The ability to accommodate a particular UUV is somewhat dependent upon the portion of, and the manner in which, the UUV is to be secured by, for example, docking system 900. The UUV would need to be positioned close enough to that operational part of docking system 900 (in particular, the toggled magnets within docking system 900 and in operational proximity to and part of that portion of surface 906 that comes into contact with the applicable UUV), will secure the UUV. Accordingly, the access to surface 906 in the proximity of the ‘docking’ area needs to be adequate. In particular embodiments of the present invention, the accommodation for the area of surface 906 is sized and configure to allow therewith the proximate locating of an adequate area of a UUV docking gear.

One of ordinary skill in the art would recognize that the communication between UUVs and the inventive docking system could be accomplished through the use of wireless technology. Docking system 900 could have the ability to communicate wirelessly with the UUVs and with one or more human operators/users situated in one or more locations that are distal from the location of docking system 900 through antenna 910.

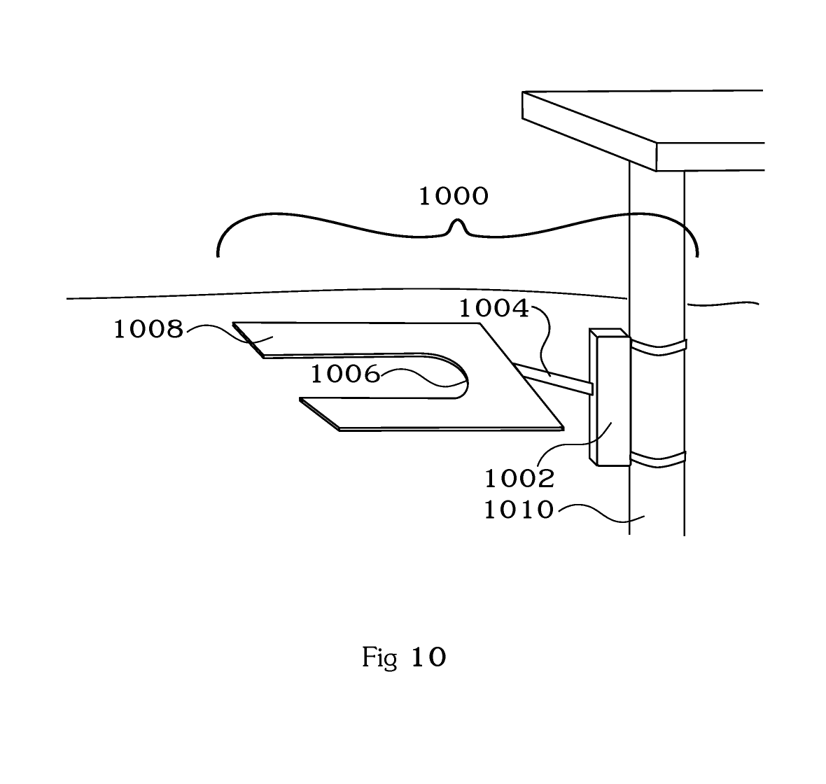

FIG. 10 shows an embodiment of the present invention that can be used with USVs. In this general case, the apparatus of the present invention allows USVs to be positioned on the surface of a body of water where the USVs are intended to float for a relatively long time before being deployed or redeployed. Such vehicles would preferably include wireless communications technology through which they could communicate with the ‘main control center’ and/or the docking systems and may also (or alternatively) include an autonomous autopilot capable of navigation the surface of the body of water to which they are assigned. For cluttered environments, like the UAVs and UUVs discussed previously, such USVs would preferably include functionality through which they could ‘sense and avoid’. Also, the USVs could similarly be capable of carrying a mission-specific payload (camera, sample collector, other sensors).

In this particular depiction of one embodiment of the present invention—FIG. 10 shows docking system 1000. Base 1002, the foundation of docking system 1000, has been secured into pillar 1010 of land-accessible pier. Docking system 1000 also has rods 1004 that connect mooring place 1008, with surface 1006, to base 1002. As shown in FIG. 10, surface 1006 is at the top of mooring place 1008 and mooring place 1008 is in the space of a “U”. One of ordinary skill in the art would know that the dimensions and configuration of surface 1006 could be different as the dimensions, configuration and other aspects of mooring place 1008 are changed. It is also possible that surface 1006 is an outer area of base 1002. Depending upon the desired operation and placement of docking system 1000, surface 1006 could be situated under base 1002 (for example, if docking system 1000 was to be a desired distance above the surface of the water with USVs docked under docking system 1000) or on the side of base 1002 (if, for example, the applicable USV is to be secured on the side of docking system 1000).

Preferably, surface 1006 is configured to accommodate an area of at least one USV in at least in close proximity with surface 1006. As suggested elsewhere in this document, docking system 1000 may be used in connection with USVs of various sizes, capabilities, designs, and configurations. The ability to accommodate a particular USV is somewhat dependent upon the portion of, and the manner in which, the USV is to be secured by, for example, docking system 1000. The USV would need to be positioned close enough to that operational part of docking system 1000 (in particular, the toggled magnets within docking system 1000 and in operational proximity to and under that portion of surface 1006 that comes into contact with the applicable USV), will secure the USV. Accordingly, the access to surface 1006 in the proximity of the ‘docking’ area needs to be adequate. In particular embodiments of the present invention, the accommodation for the area of surface 1006 is sized and configure to allow therewith the proximate locating of an adequate area of a USV docking gear.

One of ordinary skill in the art would recognize that the communication between USVs and the inventive docking system could be accomplished through the use of wireless technology. Docking system 1000 could have the ability to communicate wirelessly with the USVs and with one or more human operators/users situated in one or more locations that are distal from the location of docking system 1000 through antenna 1008.

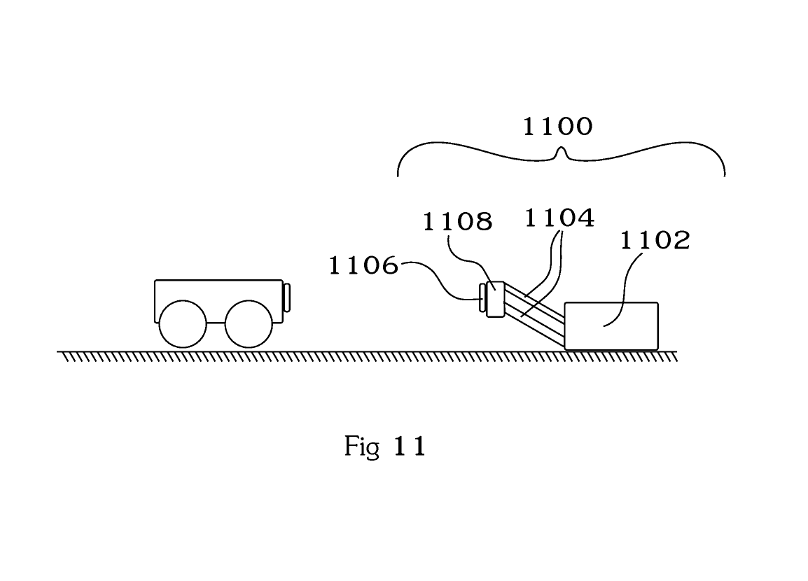

FIG. 11 shows an embodiment of the present invention that can be used with UGVs. In this general case, the apparatus of the present invention allows UGVs to be positioned on the surface of the ground where the UGVs are intended to travel for a relatively long time before being deployed or redeployed. Such vehicles would preferably include wireless communications technology through which they could communicate with the ‘main control center’ and/or the docking systems and may also (or alternatively) include an autonomous autopilot capable of navigation the surface of the terrain to which they are assigned (e.g., a forest, a desert, the facilities of a secured manufacturing plant, etc.). For cluttered environments, like the UAVs, UUVs and USVs discussed previously, such UGVs would preferably include functionality through which they could ‘sense and avoid’. Also, the UGVs could similarly be capable of carrying a mission-specific payload (camera, sample collector, other sensors).

In this particular depiction of one embodiment of the present invention—FIG. 11 shows docking system 1100. Base 1102, the foundation of docking system 1100, has been secured to the ground. Docking system 1100 also has rods 1104 that connect dock 1108, with surface 1106, to base 1102. As shown in FIG. 11, surface 1106 is in the inner portion of the “U” that comprises dock 1108. One of ordinary skill in the art would know that the dimensions and configuration of surface 1106 could be different as the dimensions, configuration and other aspects of dock 1108 are changed. It is also possible that surface 1106 is in another area of base 1102. Depending upon the desired operation and placement of docking system 1100, surface 1106 could be situated under base 1102 (for example, if docking system 1100 was to be a desired distance above the ground so UGVs could docked under docking system 1100) or on the side of base 1102 (if, for example, the applicable UGV is to be secured on the side of docking system 1100).

Preferably, surface 1106 is configured to accommodate an area of at least one UGV in at least in close proximity with surface 1106. As suggested elsewhere in this document, docking system 1100 may be used in connection with UGVs of various sizes, capabilities, designs, and configurations. The ability to accommodate a particular UGV is somewhat dependent upon the portion of, and the manner in which, the UGV is to be secured by, for example, docking system 1100. The UGV would need to be positioned close enough to that operational part of docking system 1100 (in particular, the toggled magnets within docking system 1100 and in operational proximity to and under that portion of surface 1106 that comes into contact with the applicable UGV), will secure the UGV. Accordingly, the access to surface 1106 in the proximity of the ‘docking’ area needs to be adequate. In particular embodiments of the present invention, the accommodation for the area of surface 1106 is sized and configure to allow therewith the proximate locating of an adequate area of a UGV docking gear.

One of ordinary skill in the art would recognize that the communication between UGVs and the inventive docking system could be accomplished through the use of wireless technology. Docking system 1100 could have the ability to communicate wirelessly with the UGVs and with one or more human operators/users situated in one or more locations that are distal from the location of docking system 1100 through antenna 1108.

### Additional Thoughts

The foregoing descriptions of the present invention have been provided for the purposes of illustration and description. It is not intended to be exhaustive or to limit the invention to the precise forms disclosed. Many modifications and variations will be apparent to the practitioner of ordinary skilled in the art. Particularly, it would be evident that while the examples described herein illustrate how the inventive apparatus may look and how the inventive process may be performed. Further, other elements/steps may be used for and provide benefits to the present invention. The depictions of the present invention as shown in the exhibits are provided for purposes of illustration.

The embodiments were chosen and described in order to best explain the principles of the invention and its practical application, thereby enabling others of ordinary skill in the art to understand the invention for various embodiments and with various modifications that are suited to the particular use contemplated.

1. A docking system capable of securing at least one unmanned vehicle comprising:
at least one surface configured to accommodate an area of at least one such vehicle in at least in close proximity with such at least one surface;
means of securing the position of at least one such vehicle in such close proximity to such at least one surface through the use of magnetic fields;
means of toggling, through the positioning of magnets in at least one magnet unit, the strength of such magnetic fields;
means for interacting between the docking system and at least one such vehicle; and
means for transmitting information between the docking system and a distal location [main control].

2. A docking system of claim 1 further comprising means for transferring, from such docking system, a source of energy needed to power at least one such vehicle.

3. The docking system of claim 1 further comprising means for protecting at least one such vehicle from unfavorable environment conditions.

4. The docking system of claim 1 further comprising means extracting [samples] from at least one such vehicle.

5. The docking system of claim 4 further comprising a means of storing such samples.

6. The docking system of claim 1 having more than one surface configured to accommodate at least one vehicle wherein more than one such vehicle can be secured at a time.

7. The docking system of claim 1 capable of securing differing vehicles at differing times in close proximity with one distinct surface.

8. The docking system of claim 1 further comprising means for preparing at least one such vehicle for deployment.

9. The docking system of claim 1 wherein the accommodation for the area of such at least one vehicle includes the existence of an area of the surface sized and configure to allow therewith the proximate locating of an adequate area of such vehicle's docking surface.

10. The docking system of claim 9 wherein the securing means is in close proximity to the accommodating area.

11. The docking system of claim 9 wherein the securing means is within the accommodating area.

12. The docking system of claim 1 wherein the magnetic fields of the docking system is capable of locking the docking area of at least one vehicle in physical contact with a surface with an accommodating area.

13. The docking system of claim 12 wherein such magnets in such at least one magnet unit can be mechanically moved from a magnetic field cancelling position to an active position.

14. The docking system of claim 13 in such magnets are encased in steel and such steel is capable of facilitating the desirable direction magnetic fields produced.

15. The docking system of claim 1 wherein such toggling is accomplished by electricity flowing from a battery (x) to a receiver and (y) through a switch connected to such receiver to a motor.

16. The docking system of claim 1 comprising more than one such magnetic unit and where such magnetic units can be arranged in such docking system such that the sum of the magnetic field strength of such magnet units can vary depending upon at least one such magnet unit being in an active position while at least one other such magnet unit is in an “off” position.

17. The docking system of claim 1 comprising more than one such magnetic unit configured to facilitate the increase and decrease in such magnetic fields by the toggling of such magnet units in designated ways and at specific times.

18. The docking system of claim 1 further wherein transmission of information between the docking system and at least one vehicle may occur while such vehicle is at a distal location.

19. The docking system of claim 18 further comprising means for coordinating travel to and from the docking system.

20. The docking system of claim 1 further comprising means for adjusting the accommodating area of the surface to adapt to the configurative requirements of at least one such vehicle.

21. The docking system of claim 1 further comprising means for monitoring environmental conditions and other local circumstances in the geographical proximity of such docking system.

22. A method of communicating with and securing an unmanned vehicle comprising the steps of:
transmitting at least one signal between a docking location and a distal location [main control];
initiating interaction between such docking location and at least one such vehicle;
positioning at least one such vehicle in in close proximity with the docking location; and
securing at least one such vehicle in close proximity with the docking location through the use of magnetic fields produced by toggling magnets.

23. The method of claim 22 further comprising the step of transferring as needed energy to power at least one such vehicle from the docking location.

24. The method of claim 22 further comprising the step of protecting at least one such vehicle from unfavorable environment conditions.

25. The method of claim 22 further comprising the step of preparing at least one such vehicle for deployment.

26. The method of claim 22 wherein securing is in close proximity to the accommodating area.

27. The method of claim 22 wherein the magnetic fields lock a docking area of at least one vehicle in physical contact with a surface of the docking location.

28. The method of claim 22 wherein the transmission of information between the docking location and at least one vehicle occurs while such vehicle distal from the docking location.

29. The method of claim 28 further comprising the step of coordinating travel of at least one such vehicle to and from the docking location.

30. The method of claim 22 further comprising the step of monitoring environmental conditions and other local circumstances in the geographical proximity of the docking location.
